(19) United States
(12) Patent Application Publication
(10) Pub. No.: US 2026/0280354 A1
(43) Pub. Date: Sep. 17, 2026

(54) Wireless Charging Block Bypass Apparatus and Method

(71) Applicant: Christopher Pernoud, Houston, TX (US)

(72) Inventor: Christopher Pernoud, Houston, TX (US)

(21) Appl. No.: 19/179,012

(22) Filed: Apr. 15, 2025

Related U.S. Application Data
(60) Provisional application No. 63/731,273, filed on Apr. 16, 2024.

(51) Int. Cl. H02J 50/50; H02J 50/00; H02J 50/10

(52) U.S. Cl. CPC H02J 50/50; H02J 50/005; H02J 50/10

(57) ABSTRACT

An apparatus and method for wirelessly charging an electronic device when separated by more than a nominal distance between a transmitter coil of a wireless charging device and a receiver coil of the electronic device. The apparatus and method comprising a wired block bypass comprising a pair of wire-connected first and second coils with the first coil placed substantially adjacent to the transmitter coil and the second coil placed substantially adjacent to the receiver coil.

### CROSS-REFERENCE TO RELATED APPLICATIONS

This application claims the benefit of U.S. Provisional Application Ser. No. 63/731,273, filed Apr. 16, 2024. Applicant incorporates by reference herein Application Ser. No. 63/731,273 in its entirety.

### BACKGROUND OF THE INVENTION

### 1. Field of the Invention

The present invention relates generally to wireless charging systems and methods, and more particularly to inductive charging of portable electronic devices, including mobile and handheld wireless devices.

### 2. Description of the Related Art

In recent years, it has become increasingly popular to recharge portable electrical/electronic devices, particularly mobile and handheld wireless devices, including but not limited to, cellphones, laptop and tablet computers, digital media players, and video game controllers via wireless chargers. The wireless chargers are also referred to as charging pads. Wireless charging pads are an example of near-field wireless transfer utilizing inductive charging. There are many electric wireless charging solutions in the market, typically from a powered charging pad to the electronic device. However, these wireless charging solutions typically only work with proximal or nearly-direct contact with the electronic device.

Inductive or wireless charging transfers power wirelessly by using electromagnetic induction to provide electricity to portable electronic devices. It is well known that inductive charging transfers energy through inductive coupling in which an alternating current passes through an induction coil in the charging pad and the moving electric charge creates a magnetic field. The created magnetic field fluctuates in strength because of the fluctuating electric current's amplitude. The changing magnetic field creates an alternating electric current in the induction coil of the portable electronic device, which is passed through a rectifier to convert it to direct current to charge a battery or provide operating power to the electronic device.

FIG. 1 shows an example of a conventional wireless charging pad P with an electronic device D, as for example a cellphone, placed or resting on the wireless charging pad P. Typically, a light L on the charging pad P will illuminate when charging of the electronic device D is in progress. FIG. 2 is a simplified illustration showing a receiver coil C_{R} of the electronic device positioned adjacent a transmitter coil C_{T} of the charging pad, the currents and the generated magnetic field.

Ordinary inductive coupling can only achieve high efficiency when the transmitter coil C_{T} in the charging pad P and the receiver coil C_{R} in the receiving device D are very close together, usually adjacent. For example, the receiving coil in the cellphone D is typically positioned adjacent the back of the cellphone D. As a result, the back of the cellphone D is placed on or adjacent the charging pad P when recharging the cellphone battery.

A charging problem arises when the receiver coil C_{R} of the electronic device D cannot be positioned adjacent the transmitter coil C_{T} of the charging pad P. Cases for many portable electronic devices oftentimes have additional compartments or layers, etc. that increase the distance between the receiver coil C_{R} and the transmitter coil C_{T} such that the electronic device must be removed from the case in order to wirelessly charge the electronic device. For example, many types of cellphone cases result in increased distance and/or obstructions to allowing the cellphone D to wirelessly recharge on the charging pad P. In such instances, the cellphone D may need to be removed from the phone case in order to use the wireless charging pad P. This is inconvenient and diminishes the value of the case for the electronic device D. It is also to be noted that metal positioned between closely spaced transmitter and receiver coils C_{T}, C_{R}, can also block the wireless charge from occurring.

Although the present invention applies to many types of portable electronic devices and is not limited to wireless charging of cellphones, the discussion of an embodiment of the invention will be described with reference to cellphones. Phone cases come in a variety of designs, features, and thicknesses to accommodate various accessories and functions. One type of cellphone case growing in popularity is referred to as a wallet phone case or simply a wallet case. FIGS. 3 and 3A show one example of a wallet case, generally referred to as 10. The wallet case 10 typically has a first or phone portion 12 adapted to receive and provide protection to the cellphone D while allowing full access to the phone functionality and controls. The wallet case 10 typically has one or more pockets, compartments, or sleeves 14 to store an identification card, driver's license, cash and/or credit cards, among other things. The wallet case 10 is often marketed as a purse replacement and may include a strap 16 for the purpose of carrying one's phone, driver's license, credit cards and/or cash in a small, compact, convenient, readily accessible location.

Oftentimes, the “wallet” portion 14 of the case 10 is on the back of the case which is on the backside of the cellphone D. The wallet portion 14 on the backside of the case 10 increases the distance between the cellphone receiver coil C_{R} and the charging pad transmitter coil C_{T} when the phone D and case 10 is placed on the charging pad P. Referring to FIG. 3A, this added distance typically prevents the cellphone D from charging when placed on the charging pad P. If a phone D has a thick case or wallet portion 14 attached to the back where the wireless charge is typically received, the power transfer is blocked. A phone D with an attached wallet 14 cannot use convenient wireless charging unless the wallet 14 is moved away or the phone D is removed from the case 10.

Some wallet cases 10 have the wallet portion 14 removable from the remaining portion of the case 10 and sometimes the wallet portion 14 is magnetically attached. With the wallet portion removed, the cellphone D can be recharged on the charging pad P. However, the removability of the wallet portion increases the risk of loss, misplacement, or theft of the wallet portion—none of which are desirable. Alternatively, the wallet portion may not be removable from the remainder of the case 10 which then results in a cellphone D that cannot be recharged wirelessly without removing the cellphone D from the case 10.

Many automobiles today include a wireless charging pad P in or adjacent the front console or dashboard to avoid the need for charging wires strewn about and cluttering the front inside of the vehicle and causing a potential accident risk.

There have been some efforts to overcome the wireless charging issue with wallet cases 10. An alternative solution to wireless charging has been to make the attached wallet 14 a charger which needs to be plugged in—actually not a comparable solution. Also, there are wallet portions 14 that swing away or detach to allow the wireless charger P to be close enough to the phone D, however, in tight environments such as wireless chargers P in cars there is no room to swing out the wallet portion 14.

It is desirable to have a wallet case 10 that provides maximum security against loss, misplacement or theft of the wallet portion 14 while allowing inductive charging of the cellphone battery. It is further desirable to have a method and apparatus that allows inductive charging of a portable handheld device D even when the device is not on or adjacent a charging pad P. It is further desirable to have a method and apparatus that allows inductive charging of a portable handheld device D when the device is at a distance greater than the maximum distance for charging between coils C_{T}, C_{R} of the charging pad P and receiving device D.

### SUMMARY OF THE INVENTION

One aspect of the invention includes a wired block bypass comprising a pair of wire-connected coils which can bypass the distance and any interfering materials like metal between a charging coil and a receiving coil of the receiving device. The wired block bypass directly wires the gap which wireless inductive charging cannot reach.

One aspect of the invention comprises a wallet case with a wired block bypass having first and second wire-connected coils, the first coil adjacent the back of the cellphone and the second coil on the back side of the wallet portion of the wallet case allowing the cellphone with the wallet case to be directly placed on a wireless charging device and charge without removing or swinging the battery portion out of the way.

### BRIEF DESCRIPTION OF THE SEVERAL VIEWS OF THE DRAWINGS

The invention is better understood by reading the detailed description of embodiments which follows and by examining the accompanying drawings, in which:

FIG. 1 shows a conventional wireless charger with an electronic device placed thereon;

FIG. 2 shows a receiver coil of the electronic device positioned adjacent a transmitter coil of the wireless charger, the currents and the generated magnetic field;

FIG. 3 shows an example of case for a portable electronic device;

FIG. 3A shows a side view of the case and portable electronic device of FIG. 3 positioned on the wireless charger;

FIG. 4 is a plan view of an embodiment of the present invention showing a wired block bypass comprising a pair of connected coils;

FIG. 5 is a representative view of the first and second coils of the wired block bypass positioned between the transmitter coil of the wireless charger and the receiver coil of the electronic device;

FIG. 6 is a representative view of the first and second coils of the wired block bypass positioned adjacent the transmitter coil of the wireless charger and the receiver coil of the electronic device;

FIG. 7 is an elevation view of an improved case incorporating the wired block bypass;

FIG. 8 is a simplified view taken along lines 8-8 of FIG. 7; and

FIG. 9 shows a side view of the improved case and portable electronic device of FIGS. 7 and 8 positioned on the wireless charger.

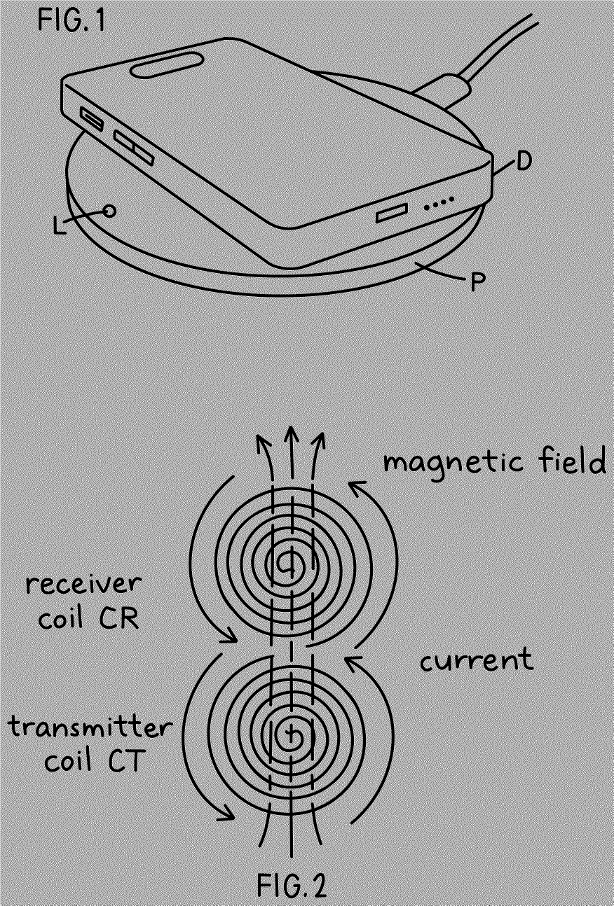

### DESCRIPTION OF THE PREFERRED EMBODIMENTS

It should be understood at the outset that although illustrative implementations of one or more embodiments are described below, the disclosed assemblies, systems and methods may be implemented using any number of techniques, whether currently known or not yet in existence. The disclosure should in no way be limited to the illustrative implementations, drawings, and techniques described below, but may be modified within the scope of the appended claims along with their full scope of equivalents.

The following brief definition of terms shall apply throughout the application:

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);
If the specification describes something as “exemplary” or an “example,” it should be understood that refers to a non-exclusive example;
The terms “about” or “approximately” or the like, when used with a number, may mean that specific number, or alternatively, a range in proximity to the specific number, as understood by persons of skill in the field of the art;
If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiment, or it may be excluded.

Embodiments of the invention will now be described with reference to the figures, in which like numerals reflect like elements throughout. The terminology used in the description presented herein is not intended to be interpreted in any restrictive or limited way, simply because it is being utilized in conjunction with the detailed description of certain specific embodiments of the invention. Furthermore, embodiments of the invention may include several novel features, no single one of which is solely responsible for its desirable attributes or which is essential to practicing the invention described herein.

With reference to FIG. 4, an embodiment of the present invention is a wired block bypass 20 comprising first and second wire-connected coils 22, 24 which can bypass the distance and any interfering materials like metal between a transmitter or charging coil C_{T} and a receiver coil C_{R} of the receiving device D. The wired block bypass 20 directly wires the gap which wireless inductive charging cannot reach. Each wire coil 22, 24 has a first wire end 22f, 24f and a second wire end 22s, 24s. Preferably, the first wire ends 22f and 24f are joined together and the second wire ends 22s and 24s are joined together, as for example by soldering. In a preferred embodiment, the first coil 22 and the second coil 24 may be identical to one another.

In a preferred embodiment, the wire-connected coils 22, 24 are each mounted on a shielding plate 22p, 24p respectively, to improve the wireless power transmission by steering the magnetic flux. The shielding plates 22p, 24p are preferably made of ferrite.

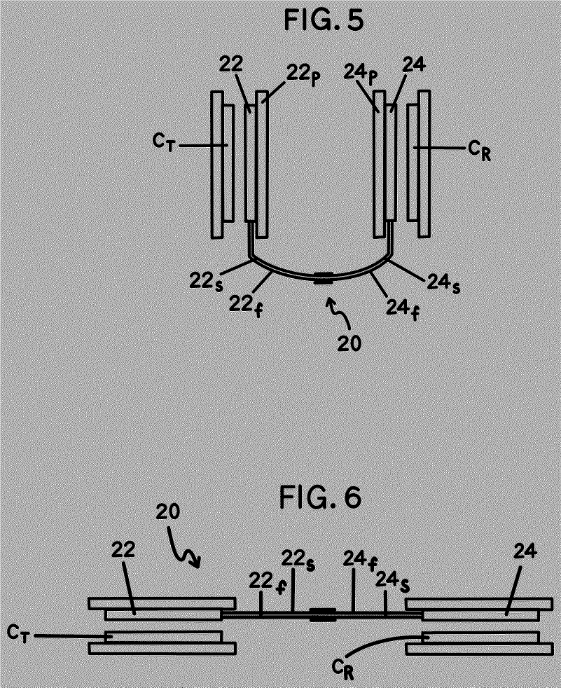

FIG. 5 is a representative view of the wired block bypass 20 positioned between the transmitter coil C_{T} of the wireless charger and the receiver coil C_{R} of the electronic device. Preferably, the first and second coils 22 and 24 face towards the adjacent transmitter coil C_{T} of the wireless charger and the receiver coil C_{R} of the electronic device during charging. Preferably, the shielding plates 22p and 24p face away from adjacent transmitter coil C_{T} of the wireless charger and the receiver coil C_{R} of the electronic device during charging. It is to be understood that the distance between the wire-connected first and second coils 22 and 24 is variable and can be substantially any length. Additionally, it is to be understood that the orientation of the first and second coils 22 and 24 with respect to each other is not important. For example, FIG. 6 shows the first and second coils 22 and 24 oriented in substantially the same plane. More significantly, the first and second coils 22 and 24 are near or adjacent the transmitter coil C_{T} of the wireless charger and the receiver coil C_{R} of the electronic device during charging. In one embodiment, the distance between the first coil 22 and the transmitter coil C_{T} and the distance between the second coil 24 and the receiver coil C_{R} should preferably not exceed 3 millimeters, and the sum of the two distances should preferably not exceed 4-5 mm, but these will depend on the charging and receiving power limits.

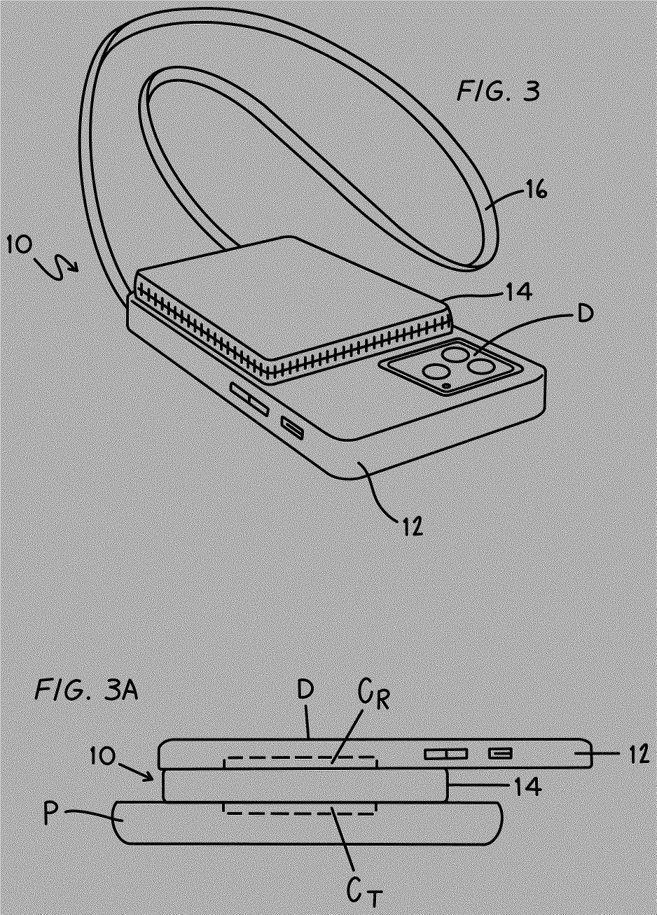

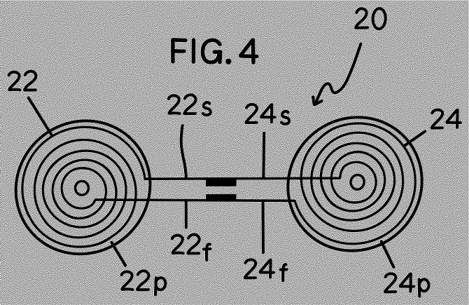

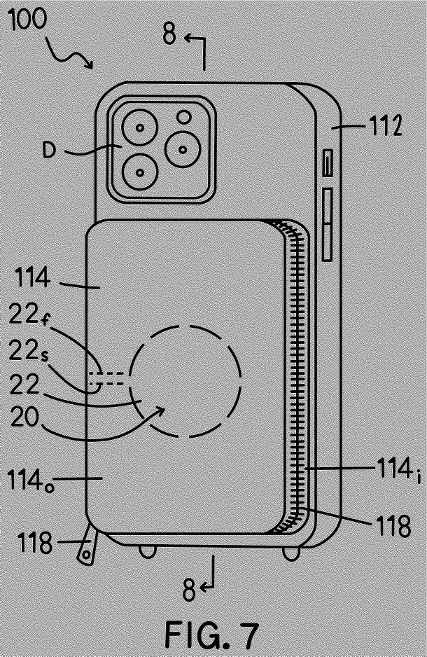

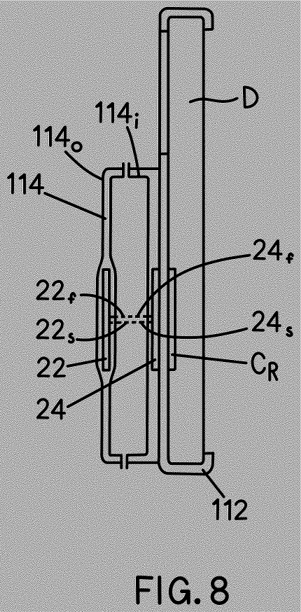

One aspect of an embodiment of the invention comprises an improved case, referred to generally as 100, as shown in FIGS. 7 and 8. The improved case 100 includes a wired block bypass 20 as described above. As stated above, the improved case 100 is not limited to the case shown in FIGS. 7 and 8 but includes any of numerous designs and styles of cases for electronic devices D. The depicted improved case 100 is the wallet case 10 shown in FIG. 3 having the wired block bypass 20 incorporated into the wallet case 10. The improved case 100 may have a first or phone portion 112 adapted to receive and provide protection to the cellphone D while allowing full access to the phone functionality and controls. The improved case 100 may have one or more pockets, compartments, or sleeves 114 to store an identification card, driver's license, cash and/or credit cards, among other things. The compartment 114 may comprise an enclosure and is shown in FIGS. 7-9 as including a zipper 118 for opening and closing the compartment 114. While merely for illustrative purposes, the compartment 114 may comprise inner and outer portions 114i and 114o, respectively, which may be joined by the zipper 118 preferably around three sides of the compartment 114. Preferably, the inner and outer portions 114i and 114o are contiguous along at least a portion of a fourth side of the compartment 114 preventing complete removal of the outer portion 114o from the improved case 100. It is to be understood that the compartment 114 may take on a variety of forms and shapes and may include interior sub-compartments, flap, sleeves, etc. for holding or storing things, such as for example, identification, credit cards, etc.

The “wallet” portion 114 of the case 100 is on the backside of the phone portion 114 of the case 100, which is adjacent the backside of the cellphone D. The improved wallet case 100 with the wired block bypass 20 has first and second wire-connected coils 22 and 24. Preferably, the first coil 22 is attached or mounted to or positioned adjacent to the outer portion 114o of the compartment 114, preferably within the compartment 114.

Preferably, the second coil 24 is attached or mounted to or positioned adjacent to the inner portion 114i of the compartment 114, preferably within the compartment 114. The second coil 24 is attached, mounted or positioned in the case 100 such that it aligns or substantially aligns with the receiver coil C_{R} of the cellphone D when received in the phone portion 112. This ensures that the second coil 24 is adjacent or substantially adjacent to the receiver coil C_{R} to thus generate the magnetic field to wirelessly charge the cellphone battery when the improved case 100 is placed on the wireless charging pad P as described below.

Preferably, the wires connecting the first and second coils 22 and 24 are adjacent to the contiguous side of the compartment 114. It is to be understood that the wired block bypass 20 is preferably concealed in the improved case 100 by methods well known to those skilled in the art. As one example, a lining may be sewn, adhered or attached on the inside of the compartment concealing the first and second coils 22 and 24 and connecting wires 22f, 22s, 24f and 24s. The wired block bypass 20 may be embedded, encased or enclosed in a case 100 or the wallet portion 114 of the improved wallet case 100.

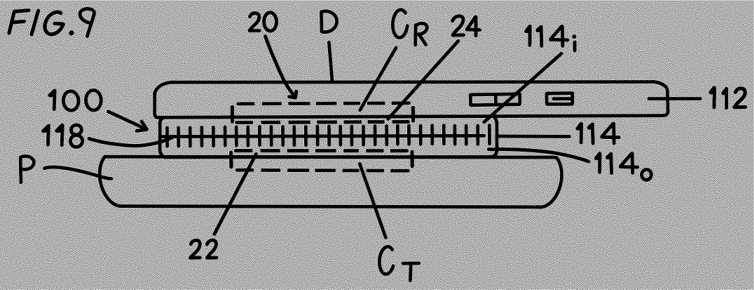

With reference to FIG. 9, the outer portion 114o of the wallet portion 114 may be positioned or directly placed on the wireless charging pad P with the cellphone D received in the phone portion 112 of the improved case 100. The wireless charging of the cellphone D can be done without removing or swinging the wallet portion 114 out of the way.
Nomenclature
electronic device D
light L
wireless charging pad P
receiver coil C_{R}
transmitter coil C_{T}
wallet case 10
phone portion 12
pockets, compartments, or sleeves 14
strap 16
wired block bypass 20
first wire-connected coil 22
first wire end 22f
shielding plate 22p
second wire end 22s
second wire-connected coil 24
first wire end 24f
shielding plate 24p
second wire end 24s
improved case 100
phone portion 112
pockets, compartments, or sleeves 114
inner portion 114i
outer portion 114o
zipper 118

While the invention has been described in detail above with reference to specific embodiments, it will be understood that modifications and alterations in the embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

What is claimed is:

1. An apparatus for wirelessly charging an electronic device when separated by more than a nominal distance between a transmitter coil of a wireless charging device and a receiver coil of the electronic device, the apparatus comprising:
a wired block bypass comprising a pair of wire-connected first and second coils.

2. The apparatus of claim 1, wherein the first coil is placed substantially adjacent to the transmitter coil and the second coil is placed substantially adjacent to the receiver coil.

3. The apparatus of claim 2, wherein the first coil is substantially aligned with the transmitter coil and the second coil is substantially aligned with the receiver coil.

4. The apparatus of claim 1, wherein the first coil has first and second wire ends and the second coil has first and second wire ends, the first wire ends of the first and second coils are joined together and the second wire ends of the first and second coils are joined together.

5. The apparatus of claim 4, wherein the first coil is identical to the second coil.

6. A method for wirelessly charging an electronic device when separated by more than a nominal distance between a transmitter coil of a wireless charging device and a receiver coil of the electronic device, the method comprising the steps of:
providing a wired block bypass comprising a pair of wire-connected first and second coils;
placing the first coil substantially adjacent to the transmitter coil; and
placing the second coil substantially adjacent to the receiver coil.

7. The method of claim 6, further comprising the steps of:
substantially aligning the first coil with the transmitter coil; and
substantially aligning the second coil with the receiver coil.

8. An improved case for an electronic device, the improved case providing ability to wirelessly charge the electronic device when in the case and when the electronic device is separated by more than a nominal distance between a transmitter coil of the wireless charging device and a receiver coil of the electronic device, the improved case comprising:
an electronic device portion for receiving the electronic device;
a second portion located between and providing more than a nominal distance between a transmitter coil of the wireless charging device and the receiver coil of the electronic device;
a first coil adapted to be positioned adjacent to the transmitter coil; and
a second coil positioned adjacent to the receiver coil,
wherein the first coil is wire-connected to the second coil.

9. The improved case of claim 8, wherein the second coil is substantially aligned with the receiver coil.

10. The improved case of claim 8, wherein the first coil has first and second wire ends and the second coil has first and second wire ends, the first wire ends of the first and second coils are joined together and the second wire ends of the first and second coils are joined together.

11. The improved case of claim 9, wherein the first coil is identical to the second coil.
